(19) United States
(12) Patent Application Publication
(10) Pub. No.: US 2007/0252353 A1
(43) Pub. Date: Nov. 1, 2007

(54) Rollable golf bag

(75) Inventors: Brian Sokol, Vermilion, OH (US); Robert F. Soreo, Cleveland Heights, OH (US)

Correspondence Address: FAY SHARPE LLP, 1100 SUPERIOR AVENUE, SEVENTH FLOOR, CLEVELAND, OH, 44114, US

(73) Assignee: GolfQuest, LLC

(21) Appl. No.: 11/522,878

(22) Filed: Sep. 15, 2006

Related U.S. Application Data
(60) Provisional application No. 60/795,342, filed on Apr. 27, 2006.

(51) Int. Cl. B62B 1/00

(52) U.S. Cl. 280/47.26

(57) ABSTRACT

A golf bag that has an enclosure for containing golf products, at least one roller cylinder or cylinder-like roller connected to the base of the golf bag for providing mobility to the golf bag, and an extendable handle to provide maneuverability to the golf bag.

The present invention claims priority on U.S. Provisional Patent Application Ser. No. 60/795,342 filed Apr. 27, 2006, which is incorporated herein by reference.

The present invention relates generally to the field of golf products, more particularly to a golf bag, even more particularly to a golf bag that can be rolled along a surface, and still even more particularly to a golf bag that can be rolled on a golf course and which minimizes the formation of channels or ruts in the golf course as the golf bag is rolled along the golf course.

### BACKGROUND OF THE INVENTION

Many country clubs and public golf courses offer players motorized golf carts so as to speed the play of a round of golf and/or make it easier for a player to carry his/her golf clubs from hole to hole. Some courses also allow golfers to walk the course, either carrying their own bag or using a caddy to carry their bag for them.

In recent years, an increased number of golfers opt to walk the golf course during their round in order to facilitate a cardiovascular workout while playing a round of golf. Many of these same golfers cannot or do not want to also carry their golf bag and clubs during the round of golf. As such, these golfers either have to forgo walking the course or have to attach their golf bag either to their own manual cart or must rent a manual cart from the golf course, if such manual cart is available to rent. These manual golf carts are usually bulky and difficult to secure to the golf bag, thereby adding frustration to the golfer. Furthermore, golfers that have invested money in the purchase of their own manual cart still have to deal with storage problems associated with the storing of the manual golf cart and golf bag in a vehicle, the assembly and disassembly of the golf bag onto and off the manual golf cart, storage problems in golf course and/or club lockers, etc.

In addition to the problems associated with walking a golf course, more golfers are taking vacations to destinations that have golf courses. On such trips, many golfers take their golf clubs. However, many golfers find it inconvenient and difficult to carry their golf bag and other luggage to and from the airport.

In view of these past problems, many concepts have been developed and marketed to address these problems. Two types of golf bag designs have evolved. One type of golf bag design incorporates a pair of wheels on the base of the golf bag. These wheels are similar to wheels used on luggage. This golf bag design is very useful to roll the golf bag over a hard surface such as an airport concourse, sidewalk, garage, etc. Examples of such golf bag designs are illustrated in US 2006/0022418; U.S. Pat. No. 6,814,361; US 2002/0190490; U.S. Pat. No. 6,279,926; and U.S. Pat. No. 6,056,301, all of which are incorporated herein by reference. Although these golf bag designs address the problems associated with transporting a golf bag over a sidewalk or airport concourse, the small wheels on these golf bags did not enable the golf bags to be rolled on a golf course. The high grass, uneven surfaces and soft ground resulted in such golf bags becoming stuck in the ground and/or caused damage to the golf bag as the golf bag was forcefully moved along the golf course. The small and narrow wheels on these golf bags also created ruts or channels in the golf course as the golf bag filled with golf clubs was moved over the golf course. In view of these limitations to such golf bags, these golf bags have not been adopted for use by players that want to walk the course during a round of golf. In addition, some golf courses have prohibited the use of such golf bags to be rolled on the golf course due to concerns about damage to the golf course.

Another golf bag design that has been developed is a golf bag that incorporates two side wheels that are similar in shape to the wheels used on standard manual golf carts. Examples of such golf bag designs are illustrated in US 2006/0011499; US 2006/0001243; US 2005/0275175; US 2005/0072695; US 2005/0029762; US 2004/0232635; US 2004/0178591; US 2004/0150176; U.S. Pat. No. 6,997,274; U.S. Pat. No. 6,874,798; U.S. Pat. No. 6,802,515; US 2004/0113380; US 2004/0090047; US 2003/0234503; US 2003/0102643; U.S. Pat. No. 6,231,059; U.S. Pat. No. 6,186,520; U.S. Pat. No. 6,182,983; U.S. Pat. No. 6,139,047; and U.S. Pat. No. 6,050,592, all of which are incorporated herein by reference. In these golf bag designs, the larger wheels are mounted on the outer sides of the golf bags. This type of mounting configuration makes the golf bag more difficult to store in a car trunk or locker at a golf course. The placement of the golf bag into and the removal of the golf bag from a car trunk can result in damage to the wheels due to the mounting location of the wheels. In some of these golf bag designs, the wheels are removable; however, these designs make it more time consuming to use the golf bag, and require the golfer to separately store the wheels. Other golf bag designs include a retractable wheel design; however, these designs take up a significant amount of space in the golf bag, make the golf bag more bulky and/or add significant weight to the golf bag. These retractable wheel designs can also be difficult to deploy or retract.

In view of the current state of the art of transportable golf bags, there is a need for a simple and ergonomically designed golf bag that can be easily and effectively transported over a variety of hard surfaces and also be used to walk a golf course, and which golf bag can be easily and conveniently stored in standard car trunks and golf lockers with little or no concern regarding damage to the components of the golf bag.

### SUMMARY OF THE INVENTION

The present invention is directed to a golf bag that overcomes many of the past problems associated with transportable golf bags.

In one non-limiting aspect of the present invention, the golf bag of the present invention includes at least one integrated roller wheel and a handle (e.g., an extendable handle, non-extendable handle, etc.). In one non-limiting embodiment of the invention, the golf bag can include one or more pockets that are used to transport and store various types of items (e.g., golf clubs, shoes, golf balls, golf gloves, umbrella, towels, score cards, pens and pencils, cell phones, keys, wallet, clothing, glasses, etc.). In an additional and/or alternative non-limiting embodiment of the invention, the golf bag can include a carrying strap that may be attached to the golf bag to enable over the shoulder carrying of the golf bag; however, this is not required. The carrying strap, when used, can be any type of carrying strap suitable for use with the golf bag (e.g., single strap type, dual strap type, etc.). In still an additional and/or alternative non-limiting embodiment of the invention, the golf bag can include one or more carrying handles to facilitate in the carrying of the golf bag; however, this is not required. In yet an additional and/or alternative non-limiting embodiment of the invention, the golf bag can include one or more connectors to enable a cover to be connected to the golf bag for use in protecting one or more golf clubs in the golf bag; however, this is not required. When used, the connector can be designed to enable the cover to be partially or fully removable from the golf bag (e.g., snaps, zipper, hook and loop fasteners, etc.); however, this is not required. In still yet an additional and/or alternative non-limiting embodiment of the invention, the golf bag can include one or more connectors to facilitate in connecting or securing the golf bag to a motorized golf cart or a manual golf cart; however, this is not required. In an additional and/or alternative non-limiting embodiment of the invention, the golf bag can include a kickstand that allows for the angled positioning of the golf bag, thereby providing easier access to golf clubs contained within the golf bag; however, the inclusion of the kickstand is not required. The kickstand, when used, is typically positioned on the backside of the golf bag; however, this is not required. When the kickstand is used, a lever device is typically used to activate the kickstand. This lever device is typically located at or near the bottom of the golf bag; however, the lever can be located in other locations on the golf bag. In one non-limiting design, the lever, when used, deploys the kickstand when the golf bag is tilted in such a manner to depress the lever. In an additional and/or alternative non-limiting design, the lever, when used, deploys the kickstand when the golfer places his/her foot on the lever and/or the lever is activated in some other manner (e.g., an electronic button, etc.). As can be appreciated, many types of mechanisms can be used to activate the kickstand, when used. In an additional and/or alternative non-limiting embodiment of the invention, the golf bag can include one or more structural elements such as internal support rails to provide stability and/or rigidity to the golf bag; however, this is not required. In one non-limiting design, the interior of the golf bag can include a base piece, attachment pieces, connecting elements, support rails, latitudinal bands and/or longitudinal rods; however, this is not required. In still an additional and/or alternative non-limiting embodiment of the invention, the golf bag can be made of a variety of material (e.g., plastic, rubber, metal, cloth, nylon, Kevlar, etc.). The outer shell or outer surface of the golf bag can also be made of a variety of material (e.g., plastic, rubber, metal, cloth, nylon, Kevlar, etc.). The inner shell or inner surface of the golf bag can be made of the same and/or different material as the outer shell or outer surface. The golf bag can be formed of one or more layers of material. In yet an additional and/or alternative non-limiting embodiment of the invention, the golf bag can include a bottom panel that ventilates the interior of the golf club storage compartment, promotes the drying of the grip ends of clubs, and/or drains the golf club storage compartment in the event of inclement weather; however, this is not required. In still yet an additional and/or alternative non-limiting embodiment of the invention, the golf bag includes an interior chamber that is designed to hold a plurality of golf clubs. The interior chamber can be partitioned; however, this is not required.

In an additional and/or alternative non-limiting aspect of the present invention, the golf bag of the present invention, the golf bag of the present invention enables a golfer to exercise by walking golf courses without having to expend energy lifting or carrying a golf bag, clubs, golf accessories and personal items. In an additional and/or alternative non-limiting embodiment of the invention, the golf bag can be designed to enable a golfer the ability to move the golf bag without having to transport, assemble, rent or otherwise procure a separate piece of equipment, such as a cumbersome non-integrated rolling cart or a motorized cart; however, this is not required. In still an additional and/or alternative non-limiting embodiment of the invention, the golf bag has the same or similar traditional dimensions and/or weight of a golf bag, thus allowing the golfer, who chooses to ride on a motorized cart, the ability to easily mount the golf bag assembly on the recessed area of the platform attached to the rear of the motorized cart; however, this is not required. In one non-limiting design, the golf bag has a weight, when empty, that is less than about 20 lbs., typically about 2-15 lbs., and more typically about 4-10 lbs. In yet an additional and/or alternative non-limiting embodiment of the invention, the golf bag can be designed to be inserted and removed from the trunk or hatch of a vehicle; however, this is not required. The golf bag is typically designed to occupy less space in a trunk or hatch of a vehicle than the space a traditional golf bag with an external or non-integrated rolling cart would occupy. In still yet an additional and/or alternative non-limiting embodiment of the invention, the golf bag can be designed to be stored in traditional golf bag storage stands, racks, lockers, bins, trunks, platforms and other similar storage configurations typically found in and around golf courses and residences; however, this is not requited. In yet an additional and/or alternative non-limiting embodiment of the invention, the golf bag can be designed to enable a golfer to travel with the golf bag either by placing the golf bag in a standard golf travel bag, case or container, or by using the golf bag itself as the travel container for the golf clubs or other equipment in the golf bag; however, this is not required.

In still an additional and/or alternative non-limiting aspect of the present invention, the golf bag of the present invention includes a roller mechanism that is designed to enable a golf bag to traverse a golf course while inhibiting or preventing the formation of ruts or channels in the golf course. Prior golf bags that included the use of a pair of casters or in-line wheels were either difficult or impossible to roll over a golf course, especially wooded areas, rough surfaces, and/or areas of tall grass. The use of casters and in-line wheels on the golf bag also created ruts or channels in the golf course, especially when the ground was wet and/or slightly to moderately soft. The roller mechanism of the present invention overcomes this past problem by the use of one or more cylinders or cylinder-like rollers positioned at or near the base of the golf bag. The one or more cylinders or cylinder-like rollers are used to increase the surface area of contact between the cylinder or cylinder-like rollers and the ground so as to better distribute the weight of the golf bag on the ground as compared to caster-type wheels, thereby inhibiting or preventing the formation of ruts or channels in the golf course as the golf bags rolled along the golf course. In one non-limiting embodiment of the invention, the golf bag includes a single cylinder or cylinder-like roller. In an additional and/or alternative non-limiting embodiment of the invention, the golf bag includes a plurality of roller cylinders or cylinder-like rollers. When a plurality of roller cylinders or cylinder-like rollers are used, the width of each cylinder or cylinder-like rollers in combination with the spacing of the cylinders from one another is selected so as to inhibit or prevent the formation of ruts or channels in the golf course as the golf bags rolled along the golf course. When a plurality of roller cylinders or cylinder-like rollers are used, the longitudinal length and average diameter of each cylinder is typically the same; however, this is not required. In one non-limiting aspect of this embodiment, the golf bag includes two roller cylinders or cylinder-like rollers. In an additional and/or alternative non-limiting aspect of this embodiment, the golf bag includes three roller cylinders or cylinder-like rollers. In still an additional and/or alternative non-limiting aspect of this embodiment, the golf bag includes four roller cylinders or cylinder-like rollers. In still yet an additional and/or alternative non-limiting aspect of this embodiment, each of the roller cylinders has generally the same longitudinal length or cylinder-like rollers. In an additional and/or alternative non-limiting aspect of this embodiment, at least one of the roller cylinders or cylinder-like rollers has a different longitudinal length from at least one other roller cylinder. In still an additional and/or alternative non-limiting embodiment of the invention, the one or more cylinders or cylinder-like rollers on the golf bag have a diameter that is sufficient size to enable the cylinder or cylinder-like rollers to traverse various surfaces on a golf course. In yet an additional and/or alternative non-limiting embodiment of the invention, when two or more roller cylinders cylinder-like rollers are used, the spacing between the roller cylinders is selected to be sufficiently small so as to not overly reduce the surface area of the roller cylinders that contact the ground surface; however, this is not required. The spacing between the roller cylinders generally is not too small so as to enable objects to become dislodged between the roller cylinders and thereby interfere with the proper operation of the roller cylinders cylinder-like rollers. The spacing between the roller cylinders cylinder-like rollers can be the same or different. In one non-limiting aspect of this embodiment, the commutative amount of space between the roller cylinders cylinder-like rollers is less than about 60% of the width of the base of the golf bag. In an additional and/or alternative non-limiting aspect of this embodiment, the commutative amount of space between the roller cylinders or cylinder-like rollers is less than about 50% of the width of the base of the golf bag. In still an additional and/or alternative non-limiting aspect of this embodiment, the commutative amount of space between the roller cylinders or cylinder-like rollers is less than about 40% of the width of the base of the golfbag. In yet an additional and/or alternative non-limiting aspect of this embodiment, the commutative amount of space between the roller cylinders or cylinder-like rollers is less than about 30% of the width of the base of the golf bag. In still yet an additional and/or alternative non-limiting aspect of this embodiment, the commutative amount of space between the roller cylinders or cylinder-like rollers is less than about 20% of the width of the base of the golf bag. In an additional and/or alternative non-limiting aspect of this embodiment, the commutative amount of space between the roller cylinders or cylinder-like rollers is less than about 10% of the width of the base of the golf bag. In still an additional and/or alternative non-limiting aspect of this embodiment, the maximum spacing between two roller cylinders or cylinder-like rollers is less than about 55% of the commutative longitudinal length of the roller cylinders or cylinder-like rollers. In yet an additional and/or alternative non-limiting aspect of this embodiment, the maximum spacing between two roller cylinders or cylinder-like rollers is less than about 40% of the commutative longitudinal length of the roller cylinders or cylinder-like rollers. In still yet an additional and/or alternative non-limiting aspect of this embodiment, the maximum spacing between two roller cylinders or cylinder-like rollers is less than about 30% of the commutative longitudinal length of the roller cylinders or cylinder-like rollers. In an additional and/or alternative non-limiting aspect of this embodiment, the maximum spacing between two roller cylinders or cylinder-like rollers is less than about 20% of the commutative longitudinal length of the roller cylinders or cylinder-like rollers. In still an additional and/or alternative non-limiting aspect of this embodiment, the maximum spacing between two roller cylinders or cylinder-like rollers is less than about 10% of the commutative longitudinal length of the roller cylinders or cylinder-like rollers. In yet an additional and/or alternative non-limiting aspect of this embodiment, the minimum spacing between two roller cylinders or cylinder-like rollers is greater than about 1% of the commutative longitudinal length of the roller cylinders or cylinder-like rollers. In still yet an additional and/or alternative non-limiting aspect of this embodiment, the minimum spacing between two roller cylinders or cylinder-like rollers is greater than about 2% of the commutative longitudinal length of the roller cylinders or cylinder-like rollers. In an additional and/or alternative non-limiting aspect of this embodiment, the minimum spacing between two roller cylinders or cylinder-like rollers is greater than about 3% of the commutative longitudinal length of the roller cylinders or cylinder-like rollers. In yet an additional and/or alternative non-limiting aspect of this embodiment, the minimum spacing between two roller cylinders or cylinder-like rollers is greater than about 4% of the commutative longitudinal length of the roller cylinders or cylinder-like rollers. In still yet an additional and/or alternative non-limiting aspect of this embodiment, the minimum spacing between two roller cylinders or cylinder-like rollers is greater than about 5% of the commutative longitudinal length of the roller cylinders or cylinder-like rollers. In still yet an additional and/or alternative non-limiting embodiment of the invention, the one or more roller cylinders or cylinder-like rollers can be formed of a variety of materials to provide durability, strength, traction, etc. to the roller cylinder or cylinder-like rollers. Non-limiting examples of materials that can be used include, but are not limited to, plastic, metal, fiber reinforced materials, wood, etc. When two or more roller cylinders or cylinder-like rollers are used, the roller cylinders or cylinder-like rollers can be formed of the same material or formed of one or more different materials. In still yet an additional and/or alternative non-limiting embodiment of the invention, the one or more roller cylinders or cylinder-like rollers can be solid, hollow or include one or more cavities. In yet an additional and/or alternative non-limiting embodiment of the invention, the one or more roller cylinders or cylinder-like rollers can be coated/covered with one or more materials to increase the life, traction, strength, etc. of the one or more roller cylinders or cylinder-like rollers; however, this is not required. Non-limiting examples of such coatings/coverings, when used, include, but are not limited to, 1) clear or color coatings that are used to a) seal and/or protect the roller cylinder or cylinder-like rollers from water or other liquids, b) seal and/or protect the roller cylinder or cylinder-like rollers from dirt, grime, etc., c) seal and/or protect the roller cylinder or cylinder-like rollers from oxidation or other types of corrosion, and/or d) provide aesthetically pleasing designs and/or colors on the one or more roller cylinders or cylinder-like rollers; and/or 2) rubber and/or polymer coating or sleeves that are used to a) seal and/or protect the roller cylinder or cylinder-like rollers from water or other liquids, b) seal and/or protect the roller cylinder or cylinder-like rollers from dirt, grime, etc., c) seal and/or protect the roller cylinder or cylinder-like rollers from oxidation or other types of corrosion, d) provide aesthetically pleasing designs and/or colors on the one or more roller cylinders or cylinder-like rollers, and/or e) improve the traction of the one or more roller cylinders or cylinder-like rollers over one or more types of surfaces. In still yet an additional and/or alternative non-limiting aspect of this embodiment, the one or more roller cylinders or cylinder-like rollers can include one or more grooves, slots, ribs, nubs, etc. that are used to improve the traction of the one or more roller cylinders or cylinder-like rollers over one or more types of surfaces; however, this is not required.

In yet an additional and/or alternative non-limiting aspect of the present invention, at least one of the one or more roller cylinders or cylinder-like rollers on the golf bag has a generally cylindrical shape. In accordance with one non-limiting embodiment of the invention, the average diameter of at least one of the roller cylinders is at least about 2.5 inches. In one non-limiting aspect of this embodiment, the average diameter of at least one of the roller cylinders is at least about 3 inches. In an additional and/or alternative non-limiting aspect of this embodiment, the average diameter of at least one of the roller cylinders is at least about 3.5 inches. In yet an additional and/or alternative non-limiting aspect of this embodiment, the average diameter of at least one of the roller cylinders is at least about 4 inches. In still yet an additional and/or alternative non-limiting aspect of this embodiment, the average diameter of at least one of the roller cylinders is at least about 5 inches. In an additional and/or alternative non-limiting aspect of this embodiment, the average diameter of at least one of the roller cylinders is about 3-10 inches. In still an additional and/or alternative non-limiting aspect of this embodiment, the average diameter of at least one of the roller cylinders is about 3.5-8 inches. In yet an additional and/or alternative non-limiting aspect of this embodiment, the average diameter of at least one of the roller cylinders is at least about 4.5-6.5 inches. In accordance with an additional and/or alternative one non-limiting embodiment of the invention, the longitudinal length of at least one of the roller cylinders is at least about 0.5 inches. In one non-limiting aspect of this embodiment, the longitudinal length of at least one of the roller cylinders is at least about 1 inch. In still an additional and/or alternative non-limiting aspect of this embodiment, the longitudinal length of at least one of the roller cylinders is at least about 2 inches. In yet an additional and/or alternative non-limiting aspect of this embodiment, the longitudinal length of at least one of the roller cylinders is about 2.5-18 inches. In still yet an additional and/or alternative non-limiting aspect of this embodiment, the longitudinal length of at least one of the roller cylinders is about 4-12 inches. In an additional and/or alternative non-limiting aspect of this embodiment, the longitudinal length of at least one of the roller cylinders is about 5-10 inches.

In still yet an additional and/or alternative non-limiting aspect of the present invention, at least one of the one or more roller cylinders or cylinder-like rollers on the golf bag has a generally hyperboloid shape along the longitudinal axis of the hyperboloid shaped roller cylinder or cylinder-like roller. The generally hyperboloid shaped roller cylinder or cylinder-like roller can be a single piece roller or be formed by a plurality of pieces. The generally hyperboloid shaped roller cylinder or cylinder-like roller can have a continuous arcuate mid-portion or transition into another shape (e.g., cylindrically shaped mid-section in the mid-portion, etc.). In one non-limiting embodiment of the invention, the generally hyperboloid shaped roller cylinder or cylinder-like roller can have a continuous arcuate mid-portion. In an additional and/or alternative non-limiting embodiment of the invention, the generally hyperboloid shaped roller cylinder or cylinder-like roller can have a non-continuous arcuate mid-portion. In one non-limiting aspect of this embodiment, at least about 20% of the longitudinal length of the roller cylinder or cylinder-like roller is arcuate shaped. In an additional and/or alternative non-limiting aspect of this embodiment, at least about 50% of the longitudinal length of the roller cylinder or cylinder-like roller is arcuate shaped. In still an additional and/or alternative non-limiting embodiment of the invention, the outer ends of the generally hyperboloid shaped roller cylinder or cylinder-like roller has a diameter at least about 2.5 inches. In one non-limiting aspect of this embodiment, the average diameter of the generally hyperboloid shaped roller cylinder or cylinder-like roller is at least about 3 inches. In an additional and/or alternative non-limiting aspect of this embodiment, the average diameter of the generally hyperboloid shaped roller cylinder or cylinder-like roller is at least about 3.5 inches. In yet an additional and/or alternative non-limiting aspect of this embodiment, the average diameter of the generally hyperboloid shaped roller cylinder or cylinder-like roller is at least about 4 inches. In still yet an additional and/or alternative non-limiting aspect of this embodiment, the average diameter of the generally hyperboloid shaped roller cylinder or cylinder-like roller is at least about 5 inches. In an additional and/or alternative non-limiting aspect of this embodiment, the average diameter of the generally hyperboloid shaped roller cylinder or cylinder-like roller is about 3-10 inches. In still an additional and/or alternative non-limiting aspect of this embodiment, the average diameter of the generally hyperboloid shaped roller cylinder or cylinder-like roller is about 3.5-8 inches. In yet an additional and/or alternative non-limiting aspect of this embodiment, the average diameter of the generally hyperboloid shaped roller cylinder or cylinder-like roller is at least about 4.5-6.5 inches. In an additional and/or alternative non-limiting embodiment of the invention, the longitudinal length of the generally hyperboloid shaped roller cylinder or cylinder-like roller is about 3-18 inches. In an additional and/or alternative non-limiting aspect of this embodiment, the longitudinal length of the generally hyperboloid shaped roller cylinder or cylinder-like roller is about 4-12 inches. In still an additional and/or alternative non-limiting aspect of this embodiment, the longitudinal length of the generally hyperboloid shaped roller cylinder or cylinder-like roller is about 5-10 inches. In still an additional and/or alternative non-limiting aspect of this embodiment, the longitudinal length of the generally hyperboloid shaped roller cylinder or cylinder-like roller is about 5.5-9 inches. In still an additional and/or alternative non-limiting embodiment of the invention, the ratio of the radius of curvature to the longitudinal length of the generally hyperboloid shaped roller cylinder or cylinder-like roller is sufficiently large enough to limit or prevent rutting of a golf course surface and/or to impart stability to the golf bag as it is pulled over flat and rough surfaces. In one non-limiting aspect of this embodiment, the ratio of the average radius of curvature of the arcuate portion to the longitudinal length of the generally hyperboloid shaped roller cylinder or cylinder-like roller is at least about 0.5:1. For instance, a hyperboloid shaped roller cylinder or cylinder-like roller having a longitudinal length of 10 inches and an average radius of curvature along the longitudinal length of about 20 inches would have a ratio of the average radius of curvature of the arcuate portion to the longitudinal length of 2:1. However, it will be appreciated that smaller ratios can be used. For instance, in an additional and/or alternative one non-limiting aspect of this embodiment, the average radius of curvature of the arcuate portion to the longitudinal length of the generally hyperboloid shaped roller cylinder or cylinder-like roller is at least about 1:1. In still an additional and/or alternative one non-limiting aspect of this embodiment, the ratio of the average radius of curvature of the arcuate portion to the longitudinal length of the generally hyperboloid shaped roller cylinder or cylinder-like roller is at least about 1.1:1. In yet an additional and/or alternative one non-limiting aspect of this embodiment, the ratio of the average radius of curvature of the arcuate portion to the longitudinal length of the generally hyperboloid shaped roller cylinder or cylinder-like roller is about 1.1-100:1. In still yet an additional and/or alternative one non-limiting aspect of this embodiment, the ratio of the average radius of curvature of the arcuate portion to the longitudinal length of the generally hyperboloid shaped roller cylinder or cylinder-like roller is about 1.2-10:1. In an additional and/or alternative one non-limiting aspect of this embodiment, the ratio of the average radius of curvature of the arcuate portion to the longitudinal length of the generally hyperboloid shaped roller cylinder or cylinder-like roller is about 1.25-2:1. In still another non-limiting aspect of this embodiment, the ratio of the average radius of curvature of the arcuate portion to the maximum diameter of the generally hyperboloid shaped roller cylinder or cylinder-like roller is at least about 0.1:1. For instance, a hyperboloid shaped roller cylinder or cylinder-like roller having a maximum diameter of 6 inches and an average radius of curvature along the longitudinal length of about 12 inches would have a ratio of the average radius of curvature of the arcuate portion to the maximum diameter of 2:1. However, it will be appreciated that smaller ratios can be used. For instance, in an additional and/or alternative one non-limiting aspect of this embodiment, the average radius of curvature of the arcuate portion to the maximum diameter of the generally hyperboloid shaped roller cylinder or cylinder-like roller is at least about 1:1. In still an additional and/or alternative one non-limiting aspect of this embodiment, the ratio of the average radius of curvature of the arcuate portion to the maximum diameter of the generally hyperboloid shaped roller cylinder or cylinder-like roller is at least about 1.1:1. In yet an additional and/or alternative one non-limiting aspect of this embodiment, the ratio of the average radius of curvature of the arcuate portion to the maximum diameter of the generally hyperboloid shaped roller cylinder or cylinder-like roller is about 1.1-100:1. In still yet an additional and/or alternative one non-limiting aspect of this embodiment, the ratio of the average radius of curvature of the arcuate portion to the maximum diameter of the generally hyperboloid shaped roller cylinder or cylinder-like roller is about 1.3-10:1. In an additional and/or alternative one non-limiting aspect of this embodiment, the ratio of the average radius of curvature of the arcuate portion to the maximum diameter of the generally hyperboloid shaped roller cylinder or cylinder-like roller is about 1.5-4:1.

In an additional and/or alternative non-limiting aspect of the present invention, at least one of the one or more roller cylinders or cylinder-like rollers on the golf bag include at least one rim that extends a small distance from the outer surface of the one or more roller cylinders; however, this is not required. The one or more rims on the one or more roller cylinders can be used to provide stability to the golf bag as the golf bag is rolled along a hard surface such as a sidewalk or air port concourse; however, this is not required. The thickness and height of the one or more rims are generally selected to cause very little, and essentially unnoticeable channeling or rutting in a ground surface. In one non-limiting aspect of this embodiment, the at least one rim has a height from an outer surface of the cylinders or cylinder-like roller of less than about 2 inches. In an additional and/or alternative non-limiting aspect of this embodiment, the at least one rim has a height from an outer surface of the cylinders or cylinder-like roller of less than about 1.5 inches. In still an additional and/or alternative non-limiting aspect of this embodiment, the at least one rim has a height from an outer surface of the cylinders or cylinder-like roller of less than about 1 inch. In yet an additional and/or alternative non-limiting aspect of this embodiment, the at least one rim has a height from an outer surface of the cylinders or cylinder-like roller of less than about 0.75 inches. In still yet an additional and/or alternative non-limiting aspect of this embodiment, the at least one rim has a height from an outer surface of the cylinders or cylinder-like roller of less than about 0.5 inches. In an additional and/or alternative non-limiting aspect of this embodiment, the at least one rim has a width of less than about 3 inches. In still an additional and/or alternative non-limiting aspect of this embodiment, the at least one rim has a width of less than about 2.5 inches. In yet an additional and/or alternative non-limiting aspect of this embodiment, the at least one rim has a width of less than about 2 inches. In yet an additional and/or alternative non-limiting aspect of this embodiment, the at least one rim has a width of less than about 1.5 inches. In still yet an additional and/or alternative non-limiting aspect of this embodiment, the at least one rim has a width of less than about 1 inch. In an additional and/or alternative non-limiting aspect of this embodiment, the at least one rim has a width of less than about 0.75 inches. In an additional and/or alternative non-limiting aspect of this embodiment, the at least one rim has a width of less than about 0.5 inches. In still an additional and/or alternative non-limiting aspect of this embodiment, at least one rim includes one or more grooves, slots, ribs, nubs, etc. that is used to improve the traction of the one or more rims over one or more types of surfaces.

In yet an additional and/or alternative non-limiting aspect of the present invention, the golf bag of the present invention can include a roller mechanism that has one or more of the roller cylinders or cylinder-like rollers having a cumulative or total width that is equal to or less than the maximum width of the base of the golf bag; however, this is not required. The position of the one or more roller cylinders or cylinder-like rollers on the roller mechanism is arranged so that the ends of the roller cylinders do not extend beyond the sides of the golf bag. As such, potential damage to the one or more roller cylinders or cylinder-like rollers is reduced or prevented when 1) the golf bag is laid on its side when placed in a vehicle, 2) the golf bag is placed in a locker, 3) the golf base is secured to a motorized cart, and/or 4) handles by baggage handles at air ports, etc. In addition, by ensuring that the one or more roller cylinders or cylinder-like rollers on the roller mechanism are arranged so that the ends of the roller cylinders or cylinder-like rollers do not extend beyond the sides of the golf bag, the golf bag can be 1) placed in traditional golf bag storage stands, racks, lockers, bins, trunks, platforms and other similar storage configurations typically found in and around golf courses and residences, 2) inserted in standard golf travel bags, cases or containers, and/or 3) place on standard manual or motorized golf carts.

In still yet an additional and/or alternative non-limiting aspect of the present invention, the golf bag of the present invention can include a roller mechanism that enables a golfer to raise and lower one or more of the roller cylinders or cylinder-like rollers; however, this is not required. In one non-limiting embodiment of the invention, one or more roller cylinders or cylinder-like rollers can be at least partially receded into the base of the golf bag so as to 1) partially hide the one or more roller cylinders or cylinder-like rollers, 2) to provide additional protection to one or more of the roller cylinders or cylinder-like rollers when not being used, and/or 3) level the golf bag on uneven surfaces. As can be appreciated, other or different reasons can be used to at least partially recede the one or more roller cylinders or cylinder-like rollers into the base of the golf bag. The receding or retracting of the one or more roller cylinders or cylinder-like rollers can be accomplished manually or electronically (e.g., use of a motor, etc.). In an additional and/or alternative non-limiting embodiment of the invention, one or more roller cylinders or cylinder-like rollers can be at least partially retracted from the base of the golf bag so as to 1) move the one or more roller cylinders from a receded position in the base of the golf bag, 2) provide additional clearance of the base of the golf bag from a ground surface, and/or 3) level the golf bag on uneven surfaces. As can be appreciated, other or different reasons can be used to at least partially recede or retract the one or more roller cylinders or cylinder-like rollers from the base of the golf bag.

In an additional and/or alternative non-limiting aspect of the present invention, the golf bag of the present invention can include a roller mechanism that enables a golfer to lock and/or unlock one or more of the roller cylinders or cylinder-like rollers so as to prevent or enable the one or more roller cylinders to rotate about the longitudinal axis of the roller cylinder or cylinder-like roller and/or to only enable one or more of the roller cylinders or cylinder-like rollers to rotate in a certain direction about the longitudinal axis of the roller cylinder or cylinder-like rollers; however, this is not required. The roller mechanism can be hand and/or foot operated (e.g., foot pedal, hand switch, etc.) and/or some type of automated or semi-automated arrangement.

In still an additional and/or alternative non-limiting aspect of the present invention, the golf bag of the present invention can include a roller mechanism that enables a golfer easily replace one or more of the roller cylinders or cylinder-like rollers; however, this is not required. During the use of the golf bag, one or more of the roller cylinders or cylinder-like rollers may become worn or damaged. The roller mechanism can be designed to allow the golfer to easily remove and replace one or more of the roller cylinders or cylinder-like rollers on the roller mechanism.

In yet an additional and/or alternative non-limiting aspect of the present invention, the golf bag of the present invention can include a retractable handle to facilitate in the rolling of the golf bag over various surfaces; however, this is not required. In one non-limiting embodiment of the invention, the handle is designed to slide in and out of the one or more rails or tubes; however, it will be appreciated that other or additional mechanisms can be used to enable the handle to retract and extend from the golf bag. Typically the retractable handle is located on the front side of the golf bag; however, this is not required. In an additional and/or alternative non-limiting embodiment of the invention, the retractable handle can include a locking and/or engagement arrangement to allow the golfer to adjust and/or control the length the retractable handle can be extended from the golf bag. In still an additional and/or alternative non-limiting embodiment of the invention, the retractable handle can be designed to fit in a compartment on the golf bag so as to conceal and/or protect the retractable handle when not being used; however, this is not required. In still an additional and/or alternative non-limiting embodiment of the invention, the retractable handle can be designed to manually and/or electronically move the handle into the extended and/or retracted position.

In yet an additional and/or alternative non-limiting aspect of the present invention, the golf bag of the present invention can include a handle that is twistable or rotatable; however, this is not required. The twistable or rotatable handle, when used, can be used to facilitate in the movement of the golf bag over a variety of surfaces. In one non-limiting embodiment of the invention, the twistable or rotatable handle can be used to accommodate various types of golfers. Some golfers may prefer to grasp the handle and then pull/push the handle in a certain way. The twistable or rotatable handle can be designed to accommodate such golfers. For this particular use, the handle can be locked or keyed into one or more positions based on the golfer's preferences; however, this is not required. In an additional and/or alternative embodiment of the invention, the twistable or rotatable handle can be designed to inhibit the incidence of tipping of the golf bag as the golf bag is moved over a surface. For example, in regions of the golf course that are rough and/or include tall grass, the sudden pulling of the golf bag by the handle can cause the golf bag to tip over. In addition, when the golf bag moves over a non-smooth surface, the golf bag can begin to wobble and eventually tip over unless the golfer stops and stabilizes the golf bag. The use of the twisting or rotatable handle can be used to provide some play and shock-absorbing features to the handle configuration so as to reduce the incidence of the golf bag tipping over as the golf bag is moved over a surface; however, this is not required. In one non-limiting aspect of this embodiment, a spring arrangement can be used in association with the twistable or rotatable handle; however, this is not required. In an additional and/or alternative non-limiting aspect of this embodiment, the twistable or rotatable handle can be mounted so that it can freely twist; however, this is not required. In still an additional and/or alternative non-limiting aspect of this embodiment, the twistable or rotatable handle can be mounted so that it can be twisted to a certain position and then locked or held in such position until later released from such position; however, this is not required. In still yet an additional and/or alternative non-limiting aspect of this embodiment, the twistable or rotatable handle can be mounted so that it can be twisted and then automatically return to a certain position when the handle is released by a user; however, this is not required. In one non-limiting design, a spring arrangement can be used to return the handle to a certain position when the handle is released.

In still yet an additional and/or alternative non-limiting aspect of the present invention, the golf bag of the present invention can include one or more base abutments on or near the base of the golf bag; however, this is not required. The one or more base abutments, when included, are typically used to maintain the golf bag in an upright position when the golf bag is on a generally flat surface. The shape of the one or more base abutments is not limited to any particular shape. The one or more base abutments are spaced a sufficient distance from the roller mechanism so as to enable the golf bag to be maintained in an upright and generally stable position when the golf bag is on a generally flat surface. The one or more base abutments can also or alternatively be used to inhibit or prevent the golf bag from moving when the golf bag is on a generally flat surface or a slightly inclined surface. In one non-limiting embodiment of the invention, the length of the base abutment is typically dependent on the size of the one or more roller cylinders or cylinder-like rollers located on the base of the golf bag and/or the distance the one or more roller cylinders or cylinder-like rollers are extending from the base of the golf bag. In one non-limiting aspect of this embodiment, the base abutment has a length of less than about 8 inches. In an additional and/or alternative non-limiting aspect of this embodiment, the base abutment has a length of about 0.5-7 inches. In still an additional and/or alternative one non-limiting aspect of this embodiment, the base abutment has a length of about 1-6 inches. In an additional and/or alternative non-limiting embodiment of the invention, the base abutment includes two legs spaced apart from one another to increase the stability of the golf bag. In one non-limiting aspect of this embodiment, the two legs are spaced apart at least about 1 inch. In an additional and/or alternative non-limiting aspect of this embodiment, the two legs are spaced apart about 1.5-7 inches. In still an additional and/or alternative non-limiting aspect of this embodiment, the two legs are spaced apart about 2-6 inches. In an additional and/or alternative non-limiting embodiment of the invention, the base abutment can be formed of a durable material. Non-limiting examples of such materials include, but are not limited to, plastic and/or rubber.

In an additional and/or alternative non-limiting aspect of the present invention, the golf bag of the present invention can include additional features such as, but not limited to, a motor driven mechanism to provide assistance in overcoming initial and other frictional forces encountered in connection with the movement of the golf bag assembly, a global positioning device (GPS) to provide accurate distance and location measurements to the golfer while engaged in playing a round of golf, dedicated range finders, mobile computing devices, cooler, and mobile communication devices, etc.

It is one non-limiting object of the present invention to provide a golf bag that can be rolled over a variety of surfaces.

It is an additional and/or alternative non-limiting object of the present invention to provide a golf bag that limits or prevents the formation of ruts or channels in a golf course.

It is still an additional and/or alternative non-limiting object of the present invention to provide a golf bag that includes one or more roller cylinders or cylinder-like rollers.

It is yet an additional and/or alternative non-limiting object of the present invention to provide a golf bag that includes a retractable handle.

It is still yet an additional and/or alternative non-limiting object of the present invention to provide a golf bag that includes a rotatable handle portion.

It is an additional and/or alternative non-limiting object of the present invention to provide a golf bag that includes one or more base abutments on the base of the golf bag.

These and other advantages will become apparent to those skilled in the art upon the reading and following of this description taken together with the accompanying drawings.

### BRIEF DESCRIPTION OF THE DRAWINGS

Reference may now be made to the drawings, which illustrate various non-limiting embodiments that the invention may take in physical form and in certain parts and arrangements of parts wherein:

FIGS. 1A and 1B are elevation views of one non-limiting golf bag in accordance with the present invention;

FIGS. 2A and 2B are perspective views of non-limiting features of the retractable handle of the golf bag in accordance with the present invention;

FIG. 3 is a side view of a base portion of the golf base in accordance with FIG. 1;

FIG. 4 is a perspective view of the golf bag in accordance with FIG. 1 wherein the golf bag is in the roll position;

FIG. 5 is a perspective view of the base portion of the golf bag of FIG. 1;

FIGS. 6-12 illustrates various non-limiting variations of configurations of the roller cylinders or cylinder-like rollers for the golf bag in accordance with the present invention;

FIGS. 13-15 illustrate various aspects of the handle arrangement for the golf bag of FIG. 1;

FIGS. 16-18 illustrate various views of a cylinder-like roller on the base of the golf bag; and, FIGS. 19-22 illustrated various views of the bottom portion of the golf bag.

### DETAILED DESCRIPTION OF THE INVENTION

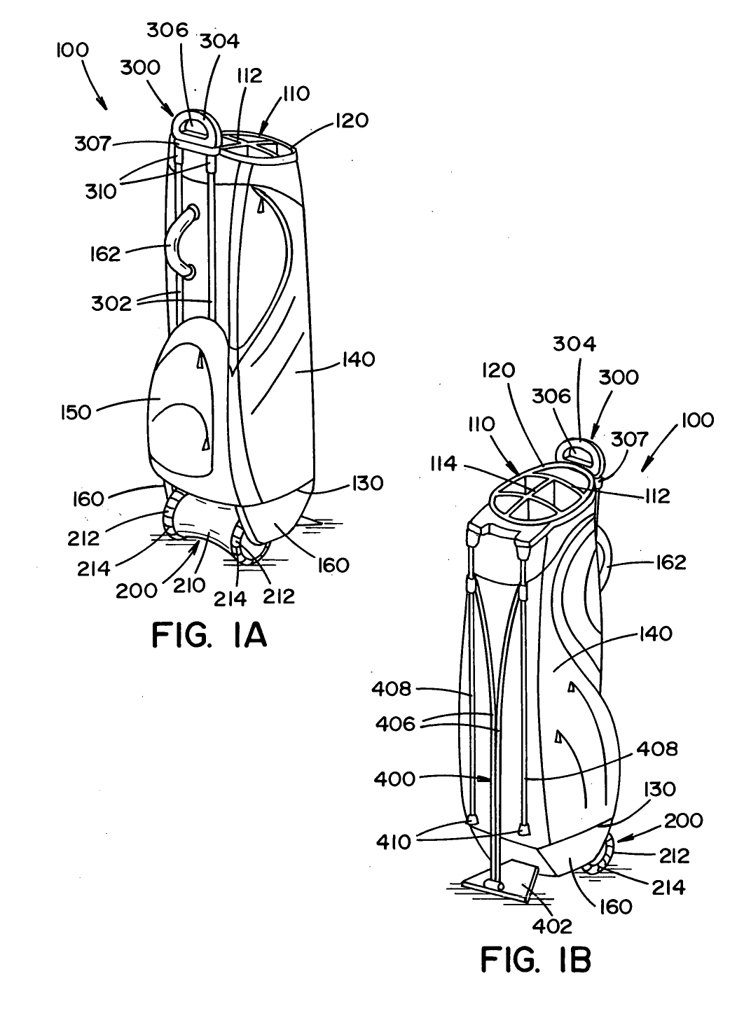

Referring now to the drawings wherein the showing is for the purpose of illustrating preferred embodiments of the invention only and not for the purpose of limiting the same, FIG. 1 discloses a golf bag 100 that includes a roller mechanism 200 in accordance with the present invention.

The golf bag includes an internal structural system 110 at least partially formed of latitudinal structures 112, more or less evenly placed at multiple horizontal levels in relation to the golf bag 100. The internal structure system also includes one or more longitudinal structures 114. These two structures at least partially provide a skeletal structure and also provide rigidity to golf bag 100. These two structures are shown to connect at their upper end to a top ring or collar 120 of the golf bag. The other ends of these structures are typically connected at their bottom end to the base of the golf bag; however, this is not required. Structures 112, 114 in combination with the collar and base of the golf bag 1) provide structural support and rigidity to the golf bag to maintain the integrity and geometry of the golf bag, and/or 2) resist forces or loads imposed on the golf bag arising from the handling and transport of the golf bag, and/or from the removal and replacement of clubs, golf accessories and personal items in the golf bag. The structures 112, 114, collar 120 and base 130 of the golf bag can be constructed from strong and rigid lightweight materials such as, but not limited to, metal, urethane foam, fiber reinforced materials, and/or plastic. The outer surface 140 of the golf bag can be formed of any durable and/or lightweight material such as, but not limited to, metal, plastic, nylon, polypropylene, canvas, fabric, Kevlar, or other similar material that can withstand natural elements and the terrain and substances normally encountered on a golf course. The outer surface of the golf bag typically includes one or more compartments 150 so as to hold various golf accessories (e.g., golf balls, umbrella, shoes, golf gloves, towels, score cards, pens and pencils, cell phones, keys, wallet, clothing, glasses, etc.). One or more of these compartments can be opened and closed with zippers, Velcro, snaps, buttons, and/or other devices. The golf bag also can include attachments for carrying straps (not shown) or hand grips 162 on the outer surface of the golf bag so as to enable golfer or caddy to carry the golf bag and/or to enable the golf bag to be mounted on a platform attached to the rear of a motorized cart, and/or mounted to a manual golf cart.

The golf bag 100 illustrated in FIGS. 1A and 1B typically has a traditionally shaped circular, oval or elliptical geometry; however, the golf bag can have non-traditional shapes (e.g., rectangular, square, etc.). In one non-limiting arrangement, the golf bag 100 encompasses traditional dimensions for golf bags so that the golf bag can be conveniently used and stored at traditional golf facilities.

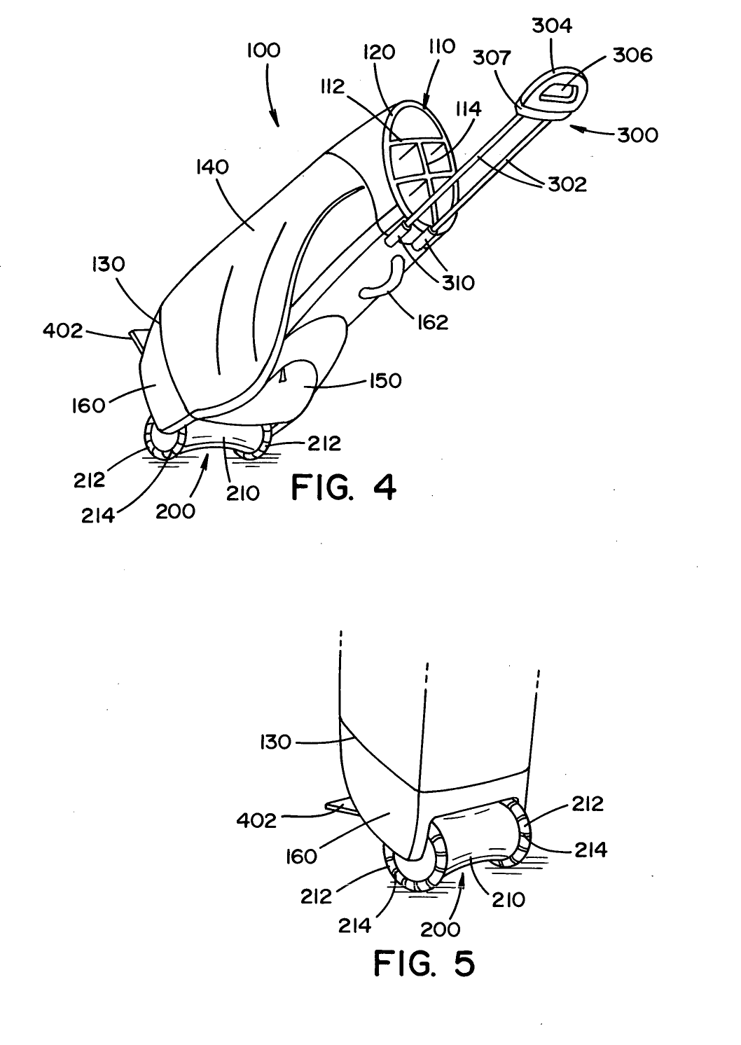

Referring now to FIGS. 1A, 3 and 16-18, the base 130 of the golf bag is connected to the roller mechanism 200. The roller mechanism includes at least one roller cylinder or cylinder-like roller 200 and a connection arrangement (not shown) to rotatably secure the roller cylinder to the base of the golf bag. The connection arrangement can be designed to enable a golfer to easily remove the roller cylinder or cylinder-like roller from the base of the golf bag; however, this is not required. In one non-limiting particular design, the roller cylinder or cylinder-like roller is not designed to be removed or replaced by a user. The roller cylinder or cylinder-like roller is shaped and sized to enable a golfer to roll the golf bag 100 over a variety of surfaces on a golf course without damaging the base of the golf bag and the surface of the golf course. As illustrated in FIG. 3, the roller cylinder or cylinder-like roller has an average body diameter of about 6 inches and a longitudinal length of about 7.5 inches. As can be appreciated, other diameters and/or longitudinal lengths of the roller cylinder or cylinder-like roller can be used. The roller cylinder or cylinder-like roller has a generally hyperboloid shape. This shape has been found to enable the roller cylinder or cylinder-like roller to roll over a variety of surfaces with limit or no rutting by the roller cylinder or cylinder-like roller. The ratio of the radius of curvature to the longitudinal length of the generally hyperboloid shaped roller cylinder or cylinder-like roller is about 1.2-2.5:1. In one non-limiting design, the roller cylinder or cylinder-like roller has a maximum diameter of about 5-7 inches, a longitudinal length of about 6-9 inches, an average radius of curvature of about 9-15 inches, and a ratio of the radius of curvature to the longitudinal length of the generally hyperboloid shaped roller cylinder or cylinder-like roller of about 1.25-1.5:1. The generally hyperboloid shape of the roller cylinder or cylinder-like roller has been found to impart several advantages to the golf bag. For example, due to the larger contact surface of the roller cylinder or cylinder-like roller as compared to in-line type wheels, the weight of the golf bag is distributed over a larger surface thereby 1) limiting or prevent the formation of ruts or channels in a golf course as the golf bag is walked along a course, 2) increasing the ease of moving the golf bag over uneven and rough surfaces on the golf course, and 3) providing added stability to the golf bag as it is pulled over a variety of surfaces. The roller cylinder or cylinder-like roller can be formed of a variety of materials such as, but not limited to, molded or blow molded plastic, rubber, metal, etc.

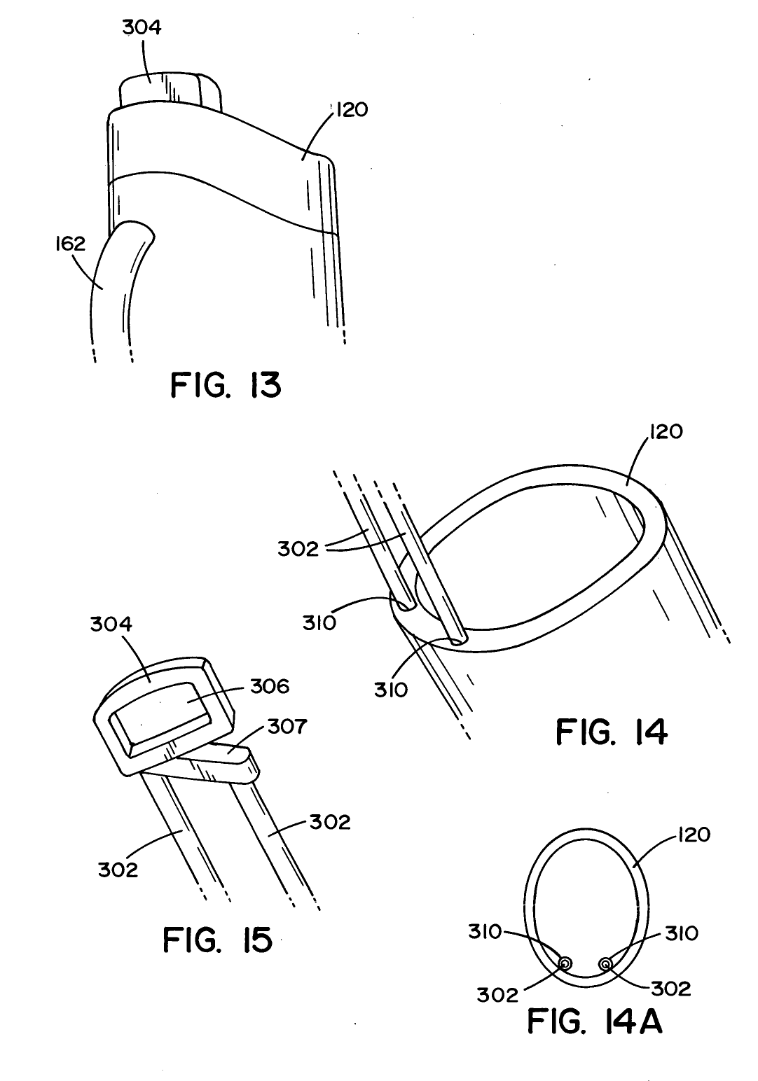

As best illustrated in FIGS. 1A, 4, 5 and 17, the longitudinal length of the roller cylinder or cylinder-like roller is typically selected so that the ends of the roller cylinder or cylinder-like roller do not extend beyond the sides of base 130. As illustrated in FIGS. 1A, 4, 5 and 17, the edges of the roller cylinder or cylinder-like roller 200 are positioned inwardly of the bottom side edge of the base. FIGS. 1A, 1B, 3, 4, 5, 17 and 18 also illustrate the golf bag having a side panel 160 that extends downwardly from base 130 and provides some protection to the sides of at least a portion of roller cylinder or cylinder-like roller 200. The side panel is particularly useful in providing protection to the roller cylinder or cylinder-like roller when the golf bag is laid in a truck or seat of a vehicle, placed in a locker, etc. The side panel can also be used to rotatably mount the roller cylinder or cylinder-like roller; however, this is not required. As illustrated in FIGS. 20 and 21, the side panel includes a mount cavity 161 designed to receive an axial end 218 of roller cylinder or cylinder-like roller 200. As can be appreciated, the roller cylinder or cylinder-like roller can be mounted to the body of the roller bag ion other or additional ways. As can also be appreciated, the side panel can form part of the housing of the roller mechanism; however, this is not required. The side panel can be formed of a variety of materials (e.g., plastic, rubber, metal, etc.).

Referring again to FIGS. 1A, 4, 5, 10, 16 and 17, a roller cylinder or cylinder-like roller 200 is shown to include two side rims 212. These side rims can be used to provide added stability to the golf bag when the golf bag is rolled over a hard, flat surface. The use of the rims on the roller cylinder or cylinder-like roller is optional. When the rims are used, the height or thickness “h” of the rims is selected so as to cause little, if any, noticeable rutting or channeling in a golf course. Typically the height or thickness of the rims 212 is no more than about 1-1.5 inches; however, this is not required. The width “w” of the rims 212 is typically small so as to only represent a small amount (e.g., less than a majority length) of the longitudinal length of the roller cylinder or cylinder-like roller. Typically the width of the rims is no more than about 1-2 inches. When the rims are used, many shapes can be used for the rims. When the rims are used, the rims can include one or more ribs, slots, grooves, etc. 214 to improve the traction of the rims on certain surfaces; however, this is not required. In addition, the body 210 of the roller cylinder or cylinder-like roller can also include one or more ribs, slots, grooves, etc. 216 to improve the traction of the roller cylinder or cylinder-like roller on certain surfaces; however, this is not required.

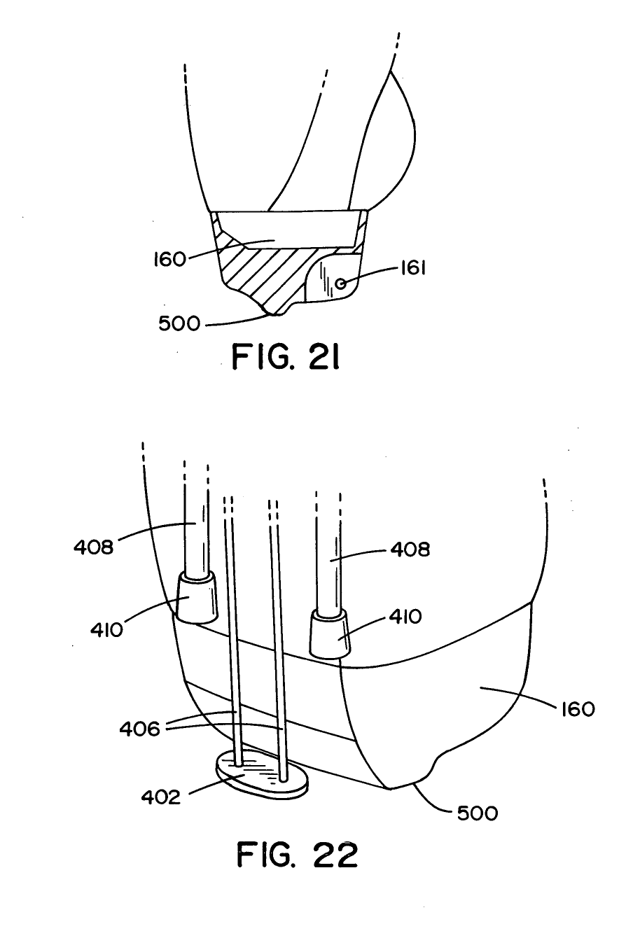

The roller cylinder or cylinder-like roller illustrated in FIG. 16 is a single part roller that is designed to enable the golf bag to be pulled over various surfaces and terrains. The roller cylinder or cylinder-like roller can be designed to be hollow and lightweight; however, this is not required. The roller cylinder or cylinder-like roller has a generally hyperboloid shape so that the roller cylinder or cylinder-like roller has two primary end points of contact when being rolled over a flat surface. The contour of the generally hyperboloid shape allows for some clearance of the mid portion or body 210 of the roller cylinder or cylinder-like roller when rolled over uneven or varied surfaces so as to facilitate in the movement of the roller cylinder or cylinder-like roller over such surfaces. The contour of the generally hyperboloid shape is also selected to enable the mid-portion or body 210 of the roller cylinder or cylinder-like roller to engage uneven surfaces as the roller cylinder or cylinder-like roller is moved over such uneven surfaces so as to provide stability to the golf bag and/or to also enable the golf bag to more easily traverse such uneven surfaces. The roller cylinder or cylinder-like roller can include a tread 216 as illustrated in FIG. 16 so as to provide improved surface contact and/or gripping roller cylinder or cylinder-like roller, thereby reducing slippage.

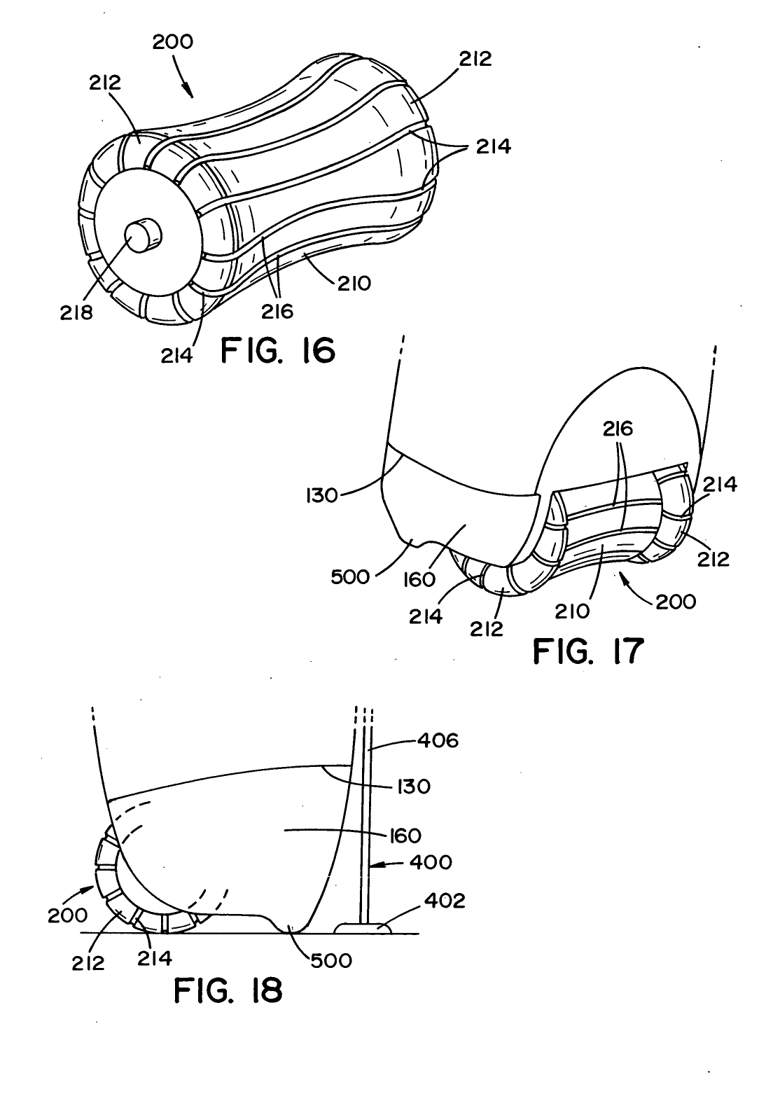

Referring now to FIGS. 6-12, several other non-limiting configurations of the roller cylinder or cylinder-like roller are illustrated that can be used in the present invention. As illustrated in FIG. 6, the roller cylinder or cylinder-like roller 200 has a generally cylinder or cylindrical shape. FIG. 7 illustrates the roller cylinder or cylinder-like roller divided into two sections. The spacing “s” between the two roller cylinders or cylinder-like rollers is selected to be sufficiently small so to not overly reduce the surface area of the roller cylinders or cylinder-like roller s that contact the ground surface. Space “s” should also not be too small so as to enable objects to become dislodged between the roller cylinders or cylinder-like rollers and thereby interfere with the proper operation of the roller cylinders or cylinder-like rollers. Typically, spacing “s” is about 1-4 inches. FIG. 8 illustrates the roller cylinder or cylinder-like roller divided into three sections. As can be appreciated, the roller cylinder or cylinder-like roller can be divided into more than three sections. As illustrated in FIGS. 7 and 8, each section of the roller cylinder or cylinder-like roller is substantially the same longitudinal length; however, it can be appreciated the longitudinal length of one or more of the sections can be different from one or more other sections. FIG. 9 illustrates the roller cylinder or cylinder-like roller as including three rims 212. As can be appreciated, the roller cylinder or each section of the roller cylinder can include any number of rims. As can also be appreciated, the rims can be positioned in a variety of locations on the roller cylinder (e.g., on the edge, spaced from the edge, in the middle, spaced from the middle, etc.). FIG. 11 illustrates a roller cylinder or cylinder-like roller in the shape of a hyperboloid shape. FIG. 12 illustrates a two-piece roller cylinder or cylinder-like roller in the shape of a hyperboloid shape.

Referring now to FIGS. 3, 17,18 and 20-22, one or more base abutments 500 are secured to the base of the golf bag. The one or more base abutments are used to maintain the golf bag in an upright position when the golf bag is on a generally flat surface. The one or more base abutments are shown to be spaced from the roller cylinder and positioned at or near the rearward portion of the golf bag. As best illustrated in FIGS. 21 and 22, the base abutment is generally designed to enable the golf bag to stand upright.

Referring now to FIGS. 1B, 3, 18, and 22, a lever 402, which will be described in more detail below, is pivotally connected to the body of the golf bag; however, this is not required. The base abutment is typically formed of a durable material (e.g., plastic, rubber, metal, etc.).

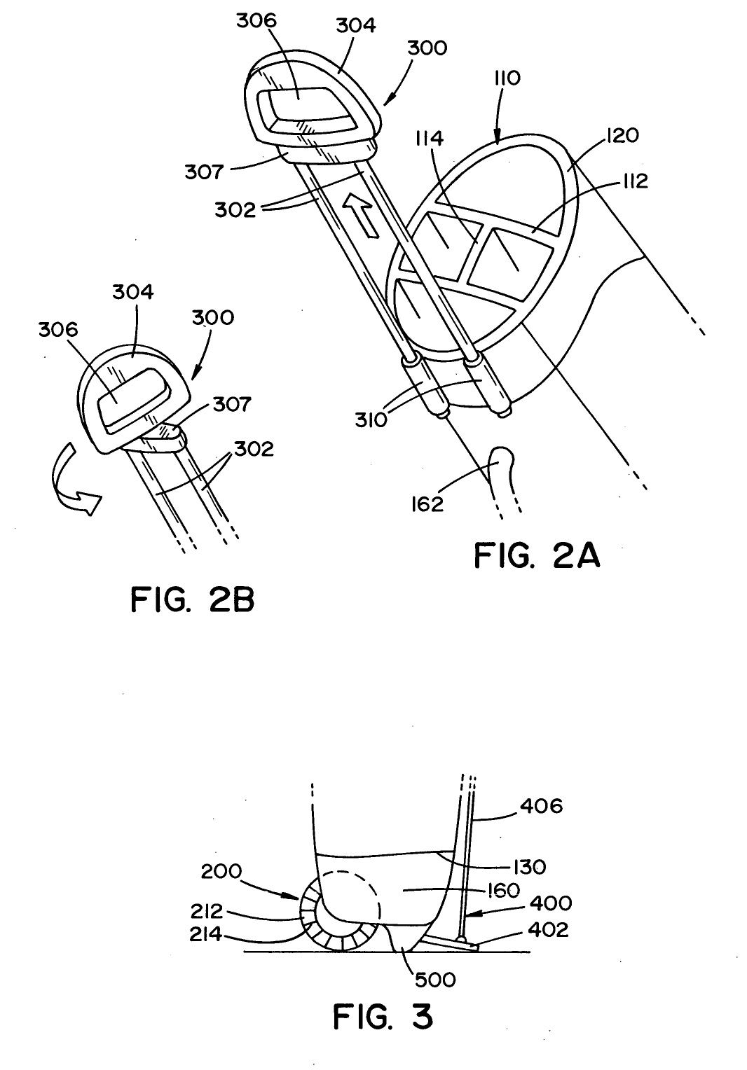

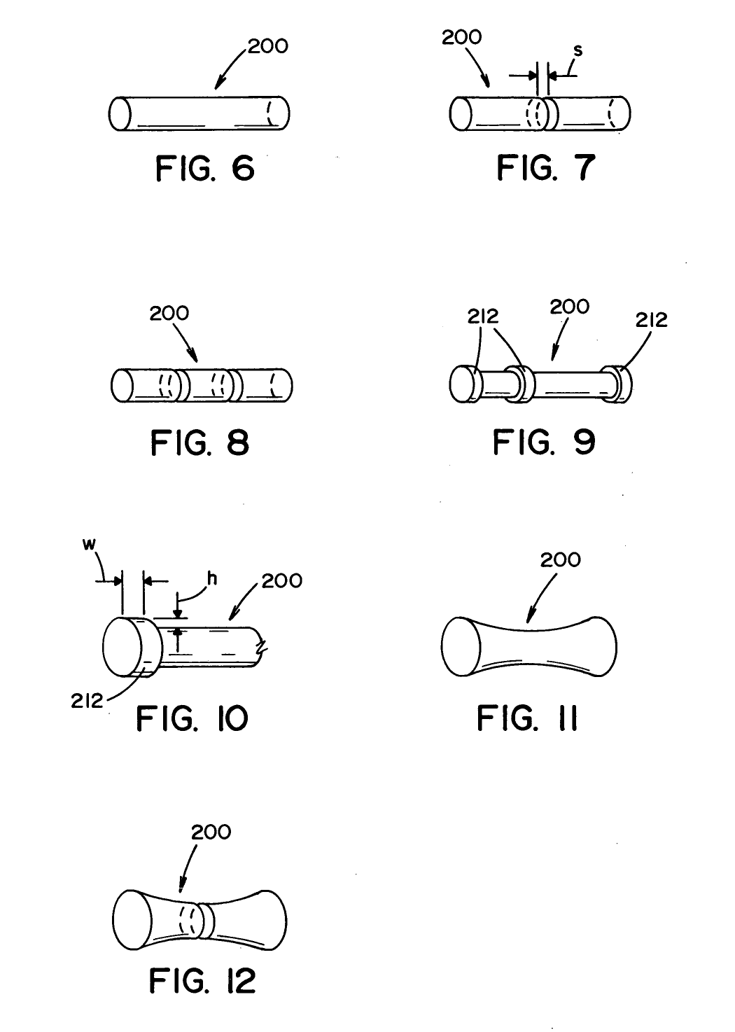

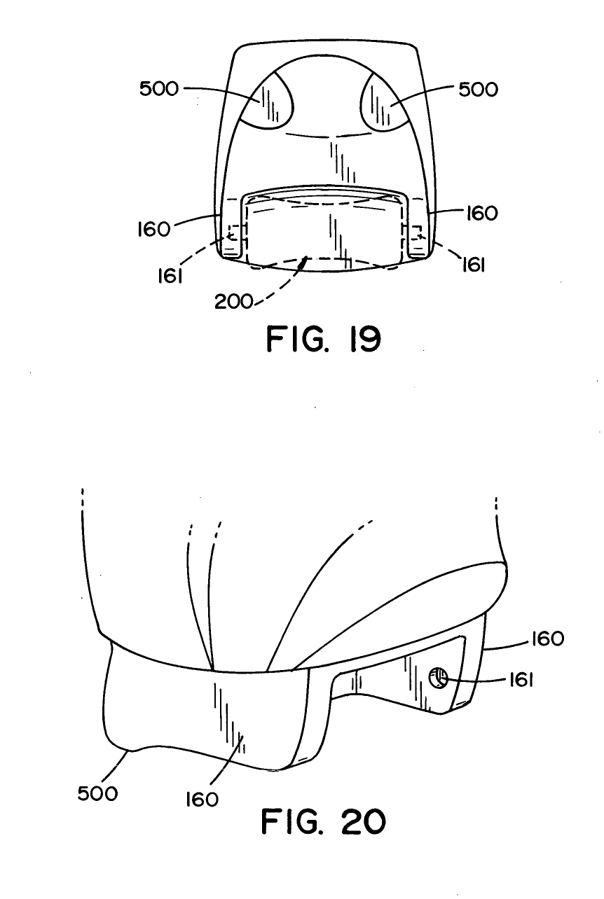

Referring now to FIGS. 1A, 2A, 2B, 4 and 13-16, the golf bag includes an extendable handle 300. The extendable handle 300 is used to assist the golfer in moving the golf bag 100 (e.g., from a vehicle to a golf course, walking the golf course, etc.) by pushing or pulling the golf bag 100 via the extendable handle 300. As illustrated in FIG. 4, the golf bag can be tilted on the roller cylinder or cylinder-like roller 200 by use of the extendable handle 300 and the golfer can then pull or push the extendable handle 300 to cause the golf bag to roll on a ground surface. The extendable handle 300 is shown to be at least partially housed inside front support rails 310. The support rails in the golf bag 100 not only enable handle 300 to be extended and retracted, the support rails can also-facilitate in providing stability and rigidity to the golf bag; however, this is not required. The support rails can be positioned on the outside region of the golf bag as illustrated in FIGS. 2A and 4, and be positioned in the top rim of the golf bag as illustrated in FIG. 14, or be inserted in the interior region of the golf bag as illustrated in FIG. 14A. The extendable handle 300 is designed to extend from a rested position on top region of the golf bag 100. The support rails can include a sliding arrangement to enable the extension rails 302 to be easily pulled out and pushed into, about and/or along the support rails. The extension rails can be formed of a single component unit or formed of a plurality of components. The extension rails can be designed to be collapsible; however, this is not required. The support rails and/or extension rails can include a mechanism (e.g., spring tab, lock, etc.) that enables the extension rails to releasably engage or lock relative to one or more locations relative to the support rails; however, this is not required. Extension rails 302 are attached to a handle 304. The extendable handle 300 can include a guard (not shown) to inhibit or prevent golf clubs from falling through space created between the extension rails and the extendable handle upon extension; however, this is not required. Handle 304 includes an opening 306 which allows a golfer to grasp the handle. When the extendable handle 300 is not extended, the extendable handle can be designed to rest generally flush with collar 120 of the golf bag 100 as illustrated in FIGS. 1A, 1B and 13. Alternatively, the extendable handle can be designed to retract into a pocket or compartment (not shown) on the golf bag so as to fully or partially conceal the handle when not in use. The extension rail 302 typically includes an arrangement (not shown) which prevents the extension rails for easily disengaging from the support rails 310.

Referring now to FIGS. 2B and 16, handle 304 is shown to be rotatable. Many arrangements can be used to enable the handle to be partially or fully rotated. The rotatable handle can be used to facilitate in the movement of the golf bag over a variety of surfaces. A spring mechanism can be used in association with the rotatable handle; however, this is not required. The rotating feature of the handle can be designed to allow the golf bag to sway freely when pulled over various surfaces while a user's arm, wrist and hand maintains a comfortable position on the handle and does not directly follow the motion of the bag. The handle can be rotatably secured to a stationary component 307, which in turn is non-rotatably secured to extension rails 302. The handle can be designed to rotate in one or more directions (e.g., clockwise rotation and/or counterclockwise rotation, etc.). The handle can be designed to include a rotation control arrangement (e.g., contour shaped handle base, spring, stop mechanism, etc.) so as to a) limit the rotational movement of the handle (e.g., limit rotation to no more than about 90°, etc.), b) lock handle so to prevent rotation, and/or c) cause the handle to return to a resting position when released (e.g., handle aligns with stationary component 307, etc.). As can be appreciated, the handle can have other or additional functions.

Referring now to FIGS. 1B, 3, 18 and 22, the golf bag can include a traditional kick stand arrangement 400; however, this is not required. The kick stand arrangement typically includes a base lever 402 and rods 406 which is used to cause two legs 408 to extend from and/or to move back to a side wall of the golf bag. The end of the two legs can include a grip arrangement 410 (e.g., rubber cover, etc.) to facilitate in the stability of the stand on various surfaces. The operation and configuration of such kick stands are well known in the art, thus will not be described in further detail.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween.

We claim:

1. A golf bag comprising an enclosure for containing golf products having a top end and a bottom end; an opening at the top end for allowing access to the golf products; a base located at the bottom end; at least one roller cylinder or cylinder-like roller rotatably connected to the base for providing mobility to the golf bag; and an extendable handle connected to the golf bag.

2. The golf bag as defined in claim 1, further comprising a kickstand.

3. The golf bag as defined in claim 1, wherein said a roller cylinder or cylinder-like roller does not extend beyond a side perimeter of the golf bag.

4. The golf bag as defined in claim 1, wherein said extendable handles includes a rotatable handle.

5. The golf bag as defined in claim 1, further comprising a base abutment.

6. The golf bag as defined in claim 5, wherein said base abutment includes two spaced apart legs.

7. The golf bag as defined in claim 1, wherein said a roller cylinder or cylinder-like roller is generally hyperboloid shaped.
